(19) United States
(12) Patent Application Publication
(10) Pub. No.: US 2002/0099814 A1
(43) Pub. Date: Jul. 25, 2002

(54) Method and apparatus for providing automatic discovery of network protocols, configurations and resources

(75) Inventor: Steven Mastrianni, Unionville, CT (US)

Correspondence Address: HARRINGTON & SMITH, LLP, 1809 BLACK ROCK TURNPIKE, FAIRFIELD, CT, 06432, US

(73) Assignee: International Business Machines Corporation, Armonk, NY (US)

(21) Appl. No.: 09/768,568

(22) Filed: Jan. 24, 2001

(51) Int. Cl. G06F 15/173; G06F 7/00; G06F 17/00

(52) U.S. Cl. 709/224; 707/104.1

(57) ABSTRACT

A method is disclosed for discovering data communication network configuration information. In the method the following steps are executed: invoking a network discovery function; executing the invoked network discovery function to examine the network using individual ones of a plurality of network configuration discovery protocols and, during the execution of the step of examining, building a list containing discovered network configuration information. The plurality of network configuration discovery protocols include a set of protocols selected from a Salutation protocol, a Service Location Protocol (SLP), a Lightweight Directory Access Protocol (LDAP), Domain Name Services (DNS) protocols, and a Dynamic Host Configuration Protocol (DHCP). The DNS protocols may include at least one of a DNS SRV Record protocol, a DNS MX Record protocol, a DNS Start of Authority Protocol, a DNA NS protocol and a DNS PTR protocol. During the execution of the step of examining the network the individual ones of the plurality of network configuration discovery protocols are executed sequentially, such as in a sequence of the Salutation protocol, the SLP, the LDAP, the DNS protocols and the DHCP. The list is preferably stored as a location object in a persistent database, and a location object may be imported into the persistent database, or exported from the persistent database. For the case where the location object is exported from the persistent database, it can be made available to be imported into another persistent database. An application program queries the persistent database for a location object, and uses the network configuration information stored in the location object while connected or attached to a network from which the location object was derived.

### FIELD OF THE INVENTION

This invention relates generally to data processing systems and communication networks and, more particularly, relates to techniques for automatically discovering and exposing the configuration of a particular data processing network, as well as the protocols that are installed on and operational on that network, and identities of at least some of the devices and services that are installed on or connected to the network.

### BACKGROUND OF THE INVENTION

A common requirement for certain data processing systems and software programs is an ability to discover the configuration of a data communication network, or simply network, that the data processing system is attached to at any given moment. For example, the network configuration at a user's office location will typically contain certain network resources, typically peripheral devices such as printers, scanners and/or shared storage. If the user's system fails, it is often replaced with a newer system that is not properly configured for the user's location since it has no a priori knowledge concerning the network configuration. Without some type of network resource discovery process the user must add the peripheral devices one by one to allow the user's system to properly use the peripheral devices. In order to add these devices the user is often required to have a record listing the device type(s), location(s) and description(s). However, the record of peripheral devices is often out-of-date, as some devices may have been removed, and other devices added, since the last time that the record was updated.

If the user's data processing system is implemented using a portable computer such as a laptop, notebook or subnotebook computer, the user may operate it in locations such as airport lounges and hotels. For example, many airports and hotels offer wired and wireless Local Area Network (LAN) connections that enable travelers to attach to a local network that provides services such as Internet access, email access, and certain peripherals such as printers. These network configurations are not known in advance to the user's computer. While some information can be discovered using industry-standard protocols such as Dynamic Host Configuration Protocol (DHCP), the results are not always optimum for enabling the user to fully exploit the potential of the local network that the user's computer happens to be attached to.

The information-gathering and administration aspects of the network configuration procedure may be arbitrarily difficult and error prone. Even if the network resource configuration is known, it is possible (and likely) that the configuration has changed from the last time the configuration information was updated. In the interim, devices may have been moved, removed, or added, or are not otherwise configured as expected. Without prior knowledge of the particular network configuration, ideally the user's computer should be enabled to, whenever possible, determine the network configuration information through some type of device and service discovery procedure. Current methods that are known to the inventor use either previous knowledge of the network configuration, or one of several independent and incompatible protocols to attempt to determine the network configuration.

Treating these conventional techniques now in turn, the most straightforward way to discover network resources is not to discover them at all, but to rely instead on previous knowledge of the network resources. The method requires the least amount of processing time while providing the greatest amount of information concerning network resources. However, because this method requires reliable information concerning the network configuration and resources it must be frequently refreshed and updated, otherwise the wrong information will be used. This technique furthermore will not work at all when attaching to a foreign network, such as one found in an airport lounge or a hotel, since the foreign network information is usually not known or exposed.

The second conventional technique typically uses one of the following protocols, or a subset of the following protocols.

One protocol is known as a Salutation Protocol, which is a product of Salutations Consortium Inc., a working group of a number of companies that represent various facets of the computer industry. These companies provide a wide range of products including computer hardware, software, facsimile machines, copies and online services. The goal is to provide a standard protocol for discovering devices and their capabilities on a network, while concealing the specifics of the underlying protocol and implementation from applications. A feature of the Salutation Protocol is a Salutation Manager that functions as a service broker responsible for managing resource interactions. The Salutation Protocol is not yet commercially deployed, and exists currently as a proposed standard. Details regarding the operation of Salutation can be obtained at www.salutation.org.

Another protocol of interest is known as the Service Location Protocol (SLP). This protocol provides a flexible and extensible environment for service discovery on an intranet. The extensibility of SLP is provided by an ability to add or remove network resources dynamically, and to have the changes reflected to the client data processing systems attached to the intranet.

SLP is flexible in that services can be added and removed without affecting the normal operation of the network. When a new service is added, a service agent advertises its services. When a user agent discovers the advertised service, and if it desires to use the service, it makes a request to the service agent for that service. When the application fishes using the service the user agent releases the service, thereby making the service available for use by other applications. The use of SLP requires that the particular network support the protocol and, at present, the use of SLP is not widespread.

A Lightweight Directory Access Protocol (LDAP) is an emerging standard for users to look up services, and for services to advertise their availability. For LDAP the user must know beforehand the address of the directory to begin a search, as well as the database schema of the LDAP data. Unlike SLP, LDAP does not make available the attribute descriptions for existing resources. LDAP uses the X.500 naming convention that has been standardized by ISO specifications, which makes the use of LDAP attractive to those companies and organizations that have standardized on the ISO requirements, However, the network must have an LDAP server installed that is kept current with any network changes.

The Domain Name Services (DNS) protocol enables discovery of some network configuration information through the use of the domain's name server. However, before the client can use the name server, it must first have the Internet Protocol (IP) of the name server to be able to resolve the names. This presents a classic problem, where the client knows the name of the name server, but the name cannot be resolved to an IP address because the client does not have the IP.

A proposed technique for service discovery is known as DNS SRV Record. This technique requires that information regarding available services be resident on the network's domain name server. External users that wish to obtain information regarding the available network services query the network's name server to discover services that are stored in a special domain name server record. When services are added or deleted, the special records in the domain name server must be updated, making DNS SRV a less dynamic form of service agent.

Another technique for service discovery is known as DNS MX Record, wherein the client can query the domain name server for the MX record that contains the address of the mail server responsible for sending mail to systems on the domain. The client can then use the contents of the MX record as the address of the mail server. Using MX records, the mail server responsible for sending mail on the network can be located anywhere in the network.

Another technique for service discovery uses what is known as DNS Start of Authority, wherein by using the Dynamic Host Configuration Protocol (DHCP) the client can obtain the address of the network's Domain Name Server (DNS). Using this address, the client then queries the DNS for the Start of Authority (SOA) record. This record contains the domain name and email address of the person responsible for administration of the domain.

In a somewhat related approach (DNA NS) the client can query the domain name server for the authoritative name server (NS) server that is delegated to provide name lookup for that particular domain. The NS record contains the name of the authoritative domain name server for the domain.

In another related approach (DNS PTR) the client can query the domain name server for the name of a network client that is associated with a particular IP. Thus, if the client knows the name of a system or resource, it can query the domain name server for the IP address so the client can contact the system or resource directly.

The above-mentioned DHCP is a request/response protocol, meaning that the DHCP client sends a Discover message seeking out any DHCP servers on the network. If a DHCP server is found, the server responds with an Offer message. The client examines the configuration information in the Offer message, and chooses the offer to accept. The client then sends the server a Request message with the offers it wants, and the server sends an acknowledge message back to the client of the offers that are granted. Once the server has granted the offers, those parameters are locked in and are no longer available to other clients. The most common use of the DHCP protocol is the automatic assignment of an IP address to a client.

Explaining now the DHCP in further detail, the most common use of DHCP is the automatic assignment of an IP address to a client. This operation is performed as follows:

1. Client broadcasts message to locate a DHCP server

2. Server responds with proposed IP address

3. Client agrees and sends Request to server

4. Server responds with ACK to confirm IP was granted

The DHCP protocol is implemented with DHCP messages. The DHCP messages are:

DHCPDISCOVER—the client sends this message to discover the DHCP server

DHCPOFFER—the server sends the offer to the client

DHCPREQUEST—the client requests one of the returned offers

DHCPACK—the server acknowledges and grants the request

DHCPNAK—the server denies the client request

DHCPDECLINE—the client declines the server's offer

DHCPRELEASE—the client releases the temporary IP address

DHCPINFORM—the client requests information from the DHCP server

DHCP is built on top of the BOOTP protocol. It allocates or “leases” IP addresses for network clients and provides storage of parameters for clients on the network. The network administrator stores the parameters on the DHCP server, and when the client contacts the DHCP server, the DHCP server provides the parameters to the clients that request them. The DHCP server provides a persistent storage of the network parameters so they can be restored in case of a power failure.

The DHCP client sends the DHCP server a request to lease an IP. The association of the IP address with a particular client is referred to as “binding”, which means that the IP address is bound to the client for a predetermined amount of time. This time is called the lease time, and the value determines how long the IP address is valid. When the lease time expires, the client sends the DHCP server a request to renew the current IP address. If the request is granted, the IP lease time is reset. If not granted, the client may ask for a new IP address from the DHCP server. When the IP is granted with an ACK from the server, the new IP address is bound to the client for the duration of the lease time.

The parameter data stored on the DHCP server is sent to the clients when they request it in special fields called Options. The Options field is a variable length field and can contain any information that the DHCP server and client agree upon beforehand. This makes the DHCP discovery process valuable only if the server and clients are aware of one another, and have previously agreed upon the format and content of the server-resident data.

The Options data consists of 76 variable length values. Each Option is specified by a reserved value defined in the DHCP RFCs. Some of the most popular requests that are issued by the client to the DHCP server include: Gateway (router) address, Domain Name Server address, Cookie server, LPR server, Domain name, Broadcast address, NIS server list, NetBIOS scope, POP3 server, NNTP servers and SMTP servers.

For users that connect to the same network all the time, DHCP is an easy way to provide information about network services, although it will work only on an intranet, and not on the Internet. Unlike agents that advertise the services available on some networks, the DHCP client must specifically ask for the configuration data it is interested in, and the network administrator must always keep the server-resident data current.

As should be apparent, the implementation of network discovery methods varies widely among computer system and software vendors. Many of the protocols are incompatible, and return information in a form that is not understood by another form of discovery protocol. Although there are standards within a particular protocol, there are almost no standards to allow the competing protocols to interoperate or to share data with another discovery method.

### OBJECTS AND ADVANTAGES OF THE INVENTION

It is a first object and advantage of this invention to provide an improved technique for the automatic discovery of protocols and services in a network environment.

It is a further object and advantage of this invention to provide a hierarchical discovery service that provides for the automatic discovery of protocols and services in a network environment using a plurality of discovery protocols, and that generates a unified network configuration data structure that is used to connect to a network.

### SUMMARY OF THE INVENTION

The foregoing and other problems are overcome and the foregoing objects and advantages are realized by methods and apparatus in accordance with embodiments of this invention.

An aspect of these teachings is providing a location object data structure that is incrementally constructed through the use of the multiple network discovery protocols, where the location object hides the specifics of the operation of the various network discovery protocols from a calling application.

This invention provides both methods and apparatus for the automatic discovery of protocols, services and devices available on a particular computer network. The method operates by encapsulating a plurality of network discovery protocols into one discovery process that is capable of sharing discovered information across competing methods and protocols. Additionally, the teachings of this invention “hide” or abstract the details of those protocols from the calling software program and is thus endian-neutral (i.e., is neutral as to whether bytes with higher significance in a word are stored at lower addresses (“little endian”) or at higher addresses (“big endian”) within the word.)

The service discovery function returns a list of available services, names, attributes, and any other required or relevant information. These may be known services and/or those discovered when the user is connected to the network. Services discovered during the connection can be dynamic or saved by location for use at a later time. Information regarding these services is stored in a persistent database. When a location is selected, an automatic binding agent connects the services to the location.

Disclosed herein is a method, a computer readable media that stores a program that implements a method or process, and a data processing system for discovering data communication network configuration information. In accordance with the method the following steps are executed: invoking a network discovery function; executing the invoked network discovery function to examine the network using individual ones of a plurality of network configuration discovery protocols and, during the execution of the step of examining, building a list containing discovered network configuration information. The plurality of network configuration discovery protocols include a set of protocols selected from a Salutation protocol, a Service Location Protocol (SLP), a Lightweight Directory Access Protocol (LDAP), Domain Name Services (DNS) protocols, and a Dynamic Host Configuration Protocol (DHCP). The DNS protocols may include at least one of a DNS SRV Record protocol, a DNS MX Record protocol, a DNS Start of Authority Protocol, a DNA NS protocol and a DNS PTR protocol. During the execution of the step of examining the network the individual ones of the plurality of network configuration discovery protocols are executed sequentially. In a presently preferred, but not limiting embodiment, the plurality of network configuration discovery protocols are executed in a sequence of the Salutation protocol, the Service Location Protocol (SLP), the Lightweight Directory Access Protocol (LDAP), the Domain Name Services (DNS) protocols, and the Dynamic Host Configuration Protocol (DHCP).

The list is preferably stored as a location object in a persistent database, and a location object may be imported into the persistent database, or exported from the persistent database. For the case where the location object is exported from the persistent database, it can be made available to be imported into another persistent database.

An application program queries the persistent database for a location object, and uses the network configuration information stored in the location object while connected or attached to a network from which the location object was derived.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 illustrates a typical network configuration for a client computer 200 containing a discovery module 400 in accordance with the teachings of this invention;

FIG. 2 is a simplified block diagram that shows the client computer 200 of FIG. 1 in greater detail; and

FIG. 3 illustrates a flow control diagram for a Discovery Module GetNetlnfo( ) Application Programming Interface (API) that implements the discovery module 400 shown in FIGS. 1 and 2.

### DETAILED DESCRIPTION OF THE INVENTION

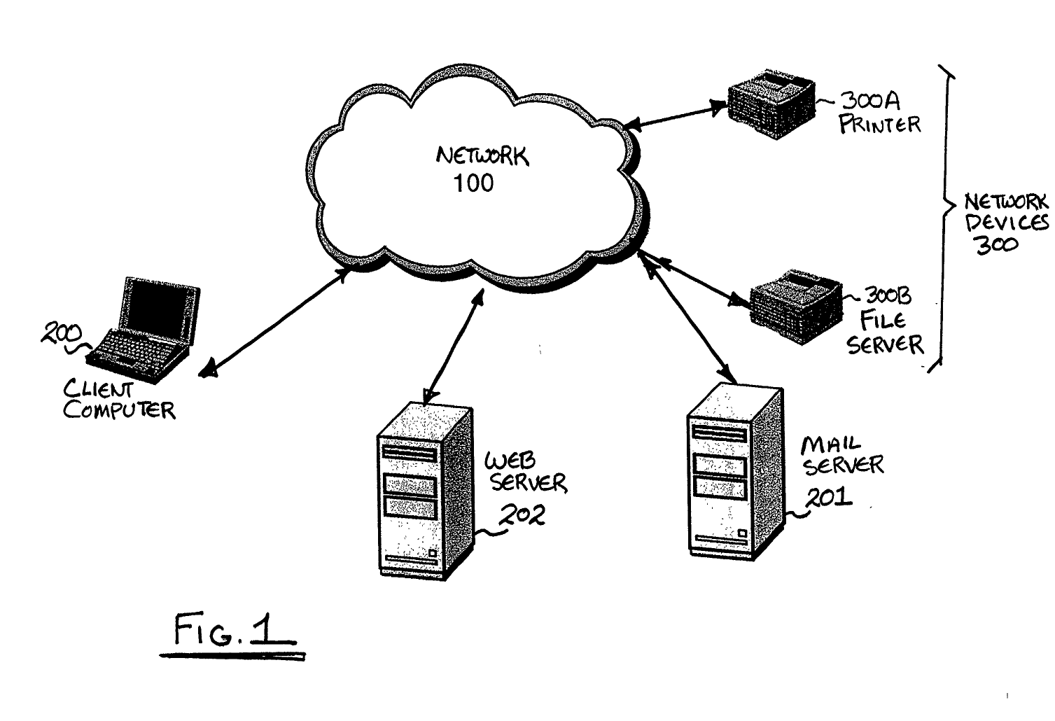

FIG. 1 illustrates a typical network 100 configuration upon which a system that implements or executes a network resources discovery module 400 in accordance with the teachings of this invention is installed or attached. In a typical, but not limiting, embodiment the discovery module 400 is installed on a portable device such as a client computer 200. The client computer 200 can be advantageously embodied by a laptop personal computer (PC) of any suitable construction and operating system. In general, other portable devices, such as personal data assistants (PDAs), notebook computers, wireless communication devices and the like, would also benefit from the use of the teachings of this invention.

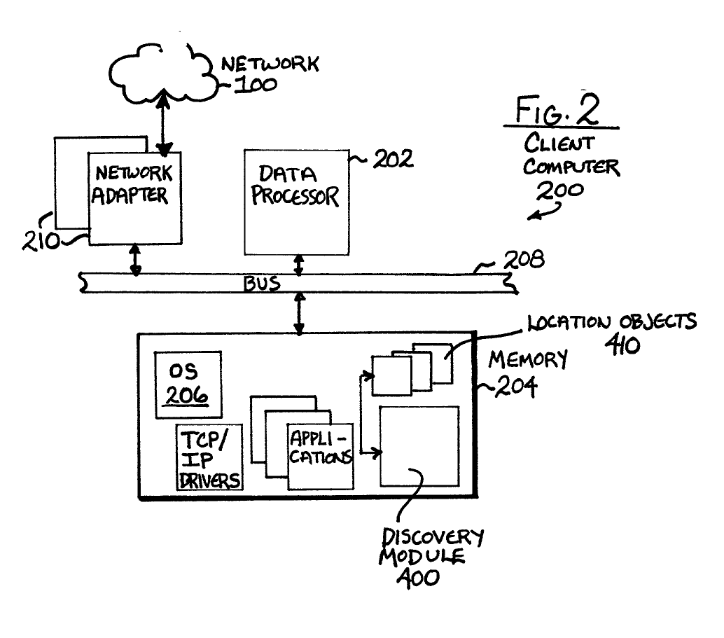

Referring also to FIG. 2, the client computer 200 includes at least one data processor, such as a Pentium®-class microprocessor 202, a memory 204, comprised of magnetic and semiconductor memory, that stores an operating system (OS) 206 such as Windows 95®, Windows 98®, Windows NT®, or Linus®, an interconnecting bus 208, and further includes appropriate hardware network adapters 210 such as at least one of a modem, a cable modem, a DSL modem, a token-ring adapter, or an Ethernet adapter, in order to connect to a network 100. Connection to the network 100 may be made via a wired link (e-g., copper wire, coaxial cable, optical fiber) or a wireless link (e.g., RF or IR link).

The client computer 200 also includes appropriate software drivers installed in the memory 204 to enable the client computer 200 to use the well-known TCP/IP communication protocol over the hardware adapters 210. In addition, the memory 204 stores all necessary software applications that a user requires to manage routine information management tasks. These applications typically include a web browser, a dialer and mail clients. The web browser can be embodied by, for example, Netscape Navigator® or Microsoft Internet Explorer®, the dialer can be embodied by, for example, AT&T's Global Network® dialer; and mail clients can be embodied by, for example, Lotus Notes®, Microsoft Outlook®, or Eudora®.

A user normally employs the client computer 200 to perform information management tasks with one or more servers connected to the network 100. These tasks include sending and receiving electronic mail from a mail server 201, retrieving web pages from a web server 202, and interacting with network devices 300, such as by printing documents on a network print server 300A, and sending and receiving data files from a file server 300B. The servers can be embodied, for example, as an IBM RISC® System 6000 computer running the AIX™ operating system, or a PC running Microsoft's NT(® Server operating system.

Assuming that the discovery module 400 is installed in the client computer 200 and resident in the memory 204, and that the client computer 200 is connected to the network 100, the discovery module 400 is invoked by the operating software installed in the computer 200 to discover the configuration of the network 100. The discovery module 400 returns to the client computer 200 a list of the devices, such as the network printer(s) 300A and/or file server(s) 300B, and as much information as is available regarding these devices. This list may be referred to as a location object 410, as it contains network-related information that is pertinent to the current location of the client computer 200. The location object 410 is stored in a persistent database, and multiple instances of the location object 410 can exist, individual ones corresponding to an individual location having a network 100 where the client computer has or may be attached. In the preferred embodiment the location object(s) 410 can be populated with network configuration data of known locations by using an import method, wherein the data is presented in a flat file format and is converted to the internal representation by the import function. The persistent database of location objects 410 may also be exported using an export function. Once exported, the network configuration data may be printed, stored on a removable media, sent via email to other users, or posted on a Web site, thereby enabling other users to import the configuration data derived a user A into their respective computing devices 200. In this manner, and by example, a business traveler is enabled to obtain and import into his or her laptop computer the network configuration data for a specific hotel where the traveler will be staying, before the traveler leaves his or her home or office.

The format of the location object 410 may be any suitable format for storing the information obtained by the various network configuration discovery functions that are executed. As an example, the location object 410 may have the form of a flat ASCII file containing fields for storing the network-configuration information returned from the discovery module 400. The location object 410 may contain a portion for storing a physical location of the network (e.g., country, state, province, time zone), a portion for storing the type of network adapter, as well as name of the DHCP server (if present) and firewall address(es), as well as a portion for storing the network resources information, including name(s) and capabilities of the network printers and the network drive(s), including drive version, drive letter, backup type, drive path information and drive data and configuration file(s). Some fields of the location object 410 may be entered by the user, such as desired web page caching information (e.g., URL, user id, password, update and depth information).

The discovery module 400 may also attempt to locate and describe other devices on the network 100, such as fax machines, modems and other types of peripherals. The discovery module 400 provides this information to the client computer 200, which in turn uses the returned information to configure the system and expose the resources, making them available to the client computer 200.

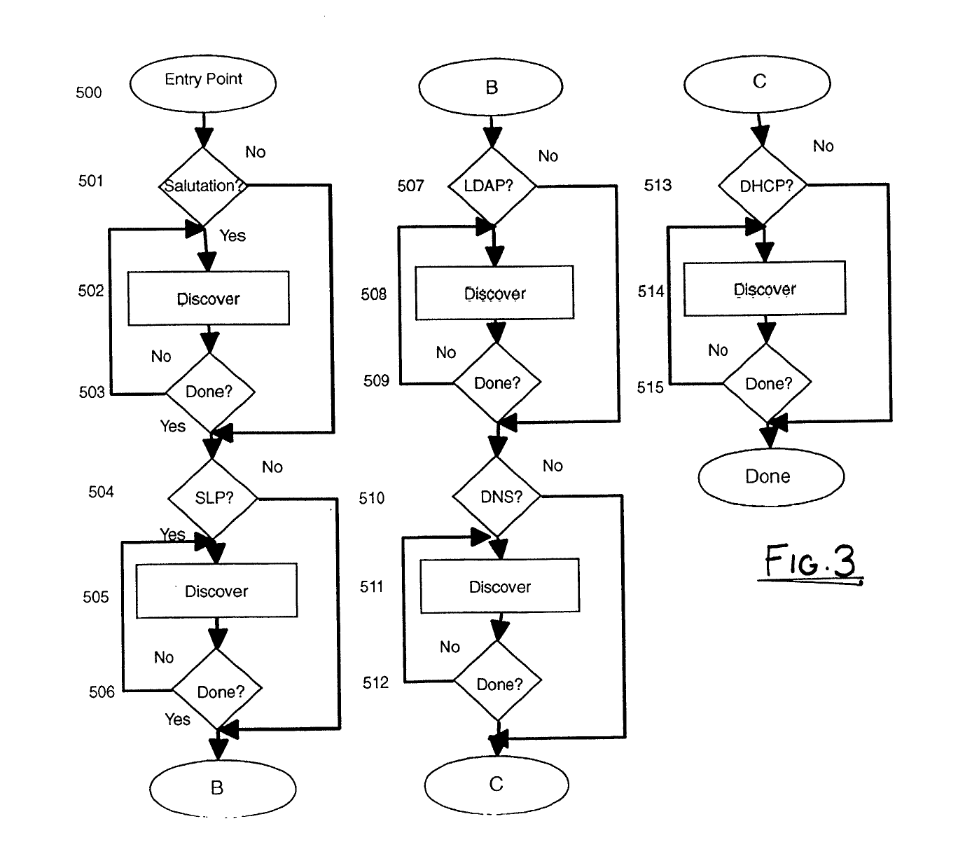

FIG. 3 shows a flow control diagram of the operation of the discovery module 400, more precisely the flow control diagram of a Get Network Information Application Protocol Interface, or more simply a GetNetlnfo( )API. After the client computer 200 is installed on or attached to the network 100 using an appropriate hardware network adapter 210, the operating system application or application program installed on the computer 200 calls the GetNetlnfo( ) API. The GetNetlnfo( ) API is entered at the Entry Point 500 and begins the discovery process by attempting to discover the network configuration using, in this nonlimiting embodiment, the Salutation protocol discovery process 501. If the initial attempt to use the Salutation protocol fails (Step 501), the discovery process begins again at Step 504 using the Service Location Protocol (SLP) discovery process at Step 505. If the initial attempt to use the Salutation protocol 501 succeeds, the Salutation discovery process searches the network 100 for attached devices 300, building a list of the devices 300 and their capabilities until no more devices can be located. The information contained in the list of devices 300 is temporarily saved in the memory 204 and the discovery process begins again, this time using the Service Location Protocol discovery service at Step 504.

If the initial attempt to use the Service Location Protocol fails, control passes to Step 507 where the discovery process begins again using the LDAP discovery process.

If the initial attempt to use the Service Location Protocol at Step 504 succeeds, at Step 505 the Service Location Protocol discovery process searches the network for the attached devices 300, building a list of the devices and their capabilities until no more devices can be located. The information contained in the list of devices is temporarily saved in the memory 204 and the discovery process begins again, this time using the LDAP discovery service at Step 507.

If the initial attempt to use the LDAP protocol at Step 507 succeeds, at Step 508 the LDAP discovery process is employed to search the network 100 for the attached devices 300, building a list of the discovered devices and their capabilities until no more devices can be located. The information contained in the list of devices is temporarily saved in memory 204 and the discovery process begins again, this time using the DNS discovery service at Step 510.

If the initial attempt to use the DNS discovery protocol fails, the discovery process begins again at Step 513 using the DHCP discovery process.

If the initial attempt to use the DNS discovery protocol succeeds at Step 510, at Step 511 the DNS discovery process searches the network 100 for attached devices 300, building a list of the devices and their capabilities until no more devices can be located. The information contained in the list of devices 300 is temporarily saved in the memory 204 and the discovery process begins again, this time using the DHCP discovery service at Step 514.

If the initial attempt to use the DHCP discovery protocol fails at Step 514, the information contained in the list of devices 300 that was temporarily saved in memory 204 is accessed and the entire contents of the discovered information, i.e., the list of devices 300 and their capabilities stored in location object 410, is returned to the software program that invoked the GetNetlnfo( ) API.

If the initial attempt to use the DHCP discovery protocol succeeds at Step 513, the DHCP discovery process searches the network at Step 514 for attached devices 300, building a list of the devices 300 and their capabilities until no more devices can be located (Step 515). At this time the information contained in the list of devices 300 that was temporarily saved in memory 204 is accessed and the entire contents of the discovered information, i-e., the list of devices 300 and their capabilities stored in location object 410, is returned to the software program that invoked the GetNetlnfo( ) API.

It can be appreciated that what has been described is a hierarchical network search and discovery procedure that provides network configuration data in the unified file format of the location object 410.

In a presently preferred embodiment the resultant location object 410 contains the network configuration for the target location, and that configuration is used to connect to the network 100. By default, the discovery module 400 first relies upon known information about the network configuration, and may only attempt to determine the network configuration if information is missing, incorrect, or if the user expressly requests that a new discovery scan be performed.

Once the configuration has been determined, the information is automatically stored in the location object 410 for that location, and multiple location objects 410 for multiple locations may be stored and archived for subsequent use. If the changes to the network configuration require a reboot, the user is instructed to reboot the client computer 200 to effect those changes. Even if the configuration is already known, the user can request the discovery module 400 to perform a new discovery to determine if the configuration has changed, or if new devices have been added.

In the preferred embodiment the discovery module 400 uses a single function call to discover the network configuration and services that are available. The GetNetlnfo( ) API function is called with three parameters.

The first parameter specifies how the discovery module 400 locates resources and configures the network 100. The caller can select the specific discovery method to use, or the caller can allow the discovery module 400 to run automatically using the hierarchical method described above with respect to FIG. 3.

The second parameter specifies the services or configuration information to locate. The calling program can select from several options such as, for example, ALL, DNS SERVER, LOCAL GATEWAY, among others. The discovery module 400 then attempts to locate the specific information using the method specified by the first function argument.

The third parameter contains a pointer to the location object 410 that already exists (for an update procedure) or that is to be created and owned by the calling program. Once the desired network configuration parameter(s) are found, the location object 410 is updated with that configuration information. It is quite possible that the information requested by the calling program cannot be located using any of the prescribed methods. In this case, the information in the location object 410 is not updated, and the status NOT_FOUND is returned to the caller.

The calling program may then choose a next course of action, which might be to use some other discovery method or to simply abandon the search entirely.

The discovery module 400 performs its discovery in a hierarchical fashion. It first checks to see if the network configuration is known. It verifies the values in the location object, and if enough information is found to connect to the network 100, the discovery module 400 returns SUCCESS. However, the user can specify that the discovery module 400 execute the discovery method shown in FIG. 3 even if the configuration exists and appears to be correct and complete. This option is preferably set to OFF by default as the discovery module 400 may require several minutes to complete it operations.

When a network discovery scan is required or requested, the discovery module 400 first attempts to discover the network configuration and resources using the Salutation protocol (Step 501). The discovery module 400 calls a function slmQueryCapability( ) to determine of the Salutation Manager (SLM) is present, indicating that the network 100 supports the Salutation protocol. The SLM returns a list of SLM Ids that are linked to Service Functional Units (SFUs). The discovery module 100 then performs a life check on the SLM and then verifies that the Service Functional Unit (SFU) is available. If so, the discovery module 400 calls the function slmOpenService to access the service described by the SFU. The SLM then in turn calls ffOpenService to ask the specific Functional Unit for access to the service.

The client then calls slmTransferData to send data to the selected Functional Unit, and the SLM calls fnReceiveData to received data from the Functional Unit.

This communication proceeds until there is no more data to be sent or received, and the client calls slmCloseService to return the service to the SLM. The SLM in turn calls fnCloseService to release the service from its current obligations. These operations correspond to the Yes branch taken at Step 503 of FIG. 3.

In the next step, the discovery module 400 attempts to discover the network configuration using SLP. The discovery module 400, posing as a User Agent (UA), looks for services on the network using the SrvTypeRqst message in a unicast or multicast fashion (Step 505 of FIG. 3). If the user is searching for a group of similar services, the multicast request is used to contact the Directory Agents (DAs), while the unicast is used to contact a specific DA. The Service Agent (SA) responds with a list of host names or IP addresses of the SAs that match the scope of the User Agent's (UA's) request in a SrvTypeReply response. The UA then issues a SrvRqst for the service, and receives SrvRply with the status of the request and the address of the service. The UA then contacts the service to retrieve the attributes of the service with an AttrRqst message, and receives the AttrRply message with the contents of the selected attributes. This process continues until the Yes branch is taken at Step 506 of FIG. 3.

In the next step, the discovery module 100 attempts to discover the network configuration using LDAP (Step 507). One consideration here is that the call to Idap_init( ) that initializes the LDAP library returns a session handle that requires the name of the domain. If the domain name exists in the location object 410, the LDAP prefix is simply added to the domain name. If the domain name is not known, the discovery module 400 uses DHCP (Step 513) to obtain the domain name, and then adds the LDAP qualifier. For example, if the domain name is abcboats.com, the LDAP host name becomes Idap.abcboats.com. The discovery module 400 calls Idap_-init( ), and if a handle is returned, it uses a series of LDAP function calls to gather information about the network 100, and then uses that information to fill in the location object 410. If a valid handle is not returned, the discovery module 400 assumes that LDAP is not installed or support on the network 100 (the No branch from Step 507 to Step 510), and proceeds to the next step in the discovery process.

In the next step, the discovery module 400 attempts to locate the network configuration using DNS services (Step 510 of FIG. 3). If the DNS server is known, the discovery module 400 requests information about the network using the above-described DNS MS, SOA, SRV, and NS record queries. If the address of the DNS server is not known, the discovery module 400 uses DCHP to find the address of the DNS server, and then uses the DNS record queries to discover the network configuration and services.

In the next step (Step 514), the discovery module 400 uses several DHCP messages to query the DHCP server on the network for configuration information. Using DHCP, the discovery module 400 attempts to determine the location of the basic network configuration and services, including the default gateway, LPR server, cookie server, network broadcast address, NetBIOS information, POP3 server, news server and NIS server list. The discovery module 400 preferably then sets the default configuration to DHCP.

Those skilled in the art should appreciate that the hierarchy of network discovery functions is preferably organized so as to first execute a function expected to provide the most comprehensive network configuration information, followed by a next function expected to provide a next most comprehensive listing of network configuration information, etc. Once a particular field or set of fields in the location object 410 has been filled in, for example, network drive configuration information, the fields are preferably not overwritten by the subsequent execution of another network configuration discovery function that may happen to discover and return the same information.

While the teachings of this invention have been described above in the context of a portable computing device (e.g. a laptop computer 200), other devices such as personal data assistants (PDAs), Palm Pilots®, portable telephones, products such as MobilePro® produced by Sharp Corporation, etc. will find equal benefit from the use of the teachings of this invention.

Furthermore, the foregoing discussion and FIG. 3 have assumed the use of certain network configuration discovery services and protocols (i.e., Salutation, SLP, LDAP, DNS and DHCP). It should be appreciated that more or less than this number of network configuration discovery services and protocols could be employed (e.g., only Salutation and SLP, or only SLP and DHCP), and that furthermore other network configuration services and protocols may be employed in place of or as an adjunct to those specifically described herein, as well as network configuration services and protocols that may be developed in the future. Furthermore, the execution of the various network configuration discovery protocols could be performed in other than the order depicted in FIG. 3.

Thus, while the invention has been particularly shown and described with respect to preferred embodiments thereof, it will be understood by those skilled in the art that changes in form and details may be made therein without departing from the scope and spirit of the invention.

What is claimed is:

1. A computer implemented method for discovering data communication network configuration information, comprising steps of:
invoking a network discovery function;
executing the invoked network discovery function for examining the network using individual ones of a plurality of network configuration discovery protocols; and
during the execution of the step of examining, building a list containing discovered network configuration information.

2. A method as in claim 1, wherein the plurality of network configuration discovery protocols comprise a set of protocols selected from a Salutation protocol, a Service Location Protocol (SLP), a Lightweight Directory Access Protocol (LDAP), Domain Name Services (DNS) protocols, and a Dynamic Host Configuration Protocol (DHCP).

3. A method as in claim 2, wherein the DNS protocols comprise at least one of a DNS SRV Record protocol, a DNS MX Record protocol, a DNS Start of Authority Protocol, a DNA NS protocol and a DNS PTR protocol.

4. A method as in claim 1, wherein during the execution of the step of examining the network using individual ones of the plurality of network configuration discovery protocols, the individual ones of the plurality of network configuration discovery protocols are executed sequentially.

5. A method as in claim 4, wherein the plurality of network configuration discovery protocols are executed in a sequence comprised of a Salutation protocol, a Service Location Protocol (SLP), a Lightweight Directory Access Protocol (LDAP), Domain Name Services (DNS) protocols, and a Dynamic Host Configuration Protocol (DHCP).

6. A method as in claim 1, wherein the list is stored as a location object in a persistent database.

7. A method as in claim 6, wherein a location object may be imported into the persistent database, or exported from the persistent database.

8. A method as in claim 6, wherein a location object may be exported from the persistent database, and made available to be imported into another persistent database.

9. A method as in claim 6, wherein an application program queries the persistent database for a location object, and uses the network configuration information stored in the location object while connected to a network from which the location object was derived.

10. A digital data storage media that is readable by a computer and that stores a software program that implements a process for discovering data communication network configuration information, the software program causing the computer to operate so as to invoke a network discovery function, to execute the invoked network discovery function to examine the network using individual ones of a plurality of network configuration discovery protocols and, during the network examination, to build a list containing discovered network configuration information.

11. A digital data storage media as claimed in claim 10, wherein the plurality of network configuration discovery protocols comprise a set of protocols selected from a Salutation protocol, a Service Location Protocol (SLP), a Lightweight Directory Access Protocol (LDAP), Domain Name Services (DNS) protocols, and a Dynamic Host Configuration Protocol (DHCP).

12. A digital data storage media as claimed in claim 11, wherein the DNS protocols comprise at least one of a DNS SRV Record protocol, a DNS MX Record protocol, a DNS Start of Authority Protocol, a DNA NS protocol and a DNS PTR protocol.

13. A digital data storage media as claimed in claim 10, wherein the computer executes individual ones of the plurality of network configuration discovery protocols sequentially in a sequence comprised of a Salutation protocol, a Service Location Protocol (SLP), a Lightweight Directory Access Protocol (LDAP), Domain Name Services (DNS) protocols, and a Dynamic Host Configuration Protocol (DHCP).

14. A digital data storage media as claimed in claim 10, wherein the computer causes the list to be stored as a location object in a persistent database, wherein a location object may be imported into the persistent database, or exported from the persistent database, and wherein a location object may be exported from the persistent database and made available to be imported into another persistent database.

15. A digital data storage media as claimed in claim 14, wherein the computer operates to respond to an application program that queries the persistent database for a location object, to return the location object to the application for use by the application while connected to a network from which the location object was derived.

16. A digital data processing system comprising a data processor, a memory, and at least one network adapter for attaching the data processor to a data communication network, said memory storing a software program that controls said data processor for discovering data communication network configuration information by examining the network using individual ones of a plurality of network configuration discovery protocols and, during the network examination, for building a location object in a persistent database portion of said memory, said location object containing discovered network configuration information for use by an application while attached to the network.

17. A digital data processing system as claimed in claim 16, wherein the plurality of network configuration discovery protocols comprise a set of protocols selected from a Salutation protocol, a Service Location Protocol (SLP), a Lightweight Directory Access Protocol (LDAP), Domain Name Services (DNS) protocols, and a Dynamic Host Configuration Protocol (DHCP).

18. A digital data processing system as claimed in claim 17, wherein the DNS protocols comprise at least one of a DNS SRV Record protocol, a DNS Mx Record protocol, a DNS Start of Authority Protocol, a DNA NS protocol and a DNS PTR protocol.

19. A digital data processing system as claimed in claim 16, wherein the data processor is controlled to execute individual ones of the plurality of network configuration discovery protocols sequentially in a sequence comprised of a Salutation protocol, a Service Location Protocol (SLP), a Lightweight Directory Access Protocol (LDAP), Domain Name Services (DNS) protocols, and a Dynamic Host Configuration Protocol (DHCP).

20. A digital data processing system as claimed in claim 16, wherein a location object may be imported into the persistent database, or exported from the persistent database, and wherein a location object may be exported from the persistent database and made available to be imported into another persistent database.
